(19) United States
(12) Patent Application Publication
(10) Pub. No.: US 2026/0005978 A1
(43) Pub. Date: Jan. 1, 2026

(54) OPTIMAL LATENCY IN DISTRIBUTED EGRESS SCHEDULED SYSTEM

(71) Applicant: Arista Networks, Inc., Santa Clara, CA (US)

(72) Inventor: Francois Labonte, Menlo Park, CA (US)

(21) Appl. No.: 18/759,427

(22) Filed: Jun. 28, 2024

(51) Int. Cl. H04L 47/52; H04L 47/56; H04L 47/62

(52) U.S. Cl. CPC H04L 47/527; H04L 47/56; H04L 47/621

(57) ABSTRACT

A networking device controls transmission to an egress port with a virtual output queue using credits received from an egress scheduler. Credits may be requested at various rates based on the size of the virtual output queue. To optimize latency and prevent unused credits, the thresholds for changing the requested credit rates is determined based on the credit rate and the round-trip time from the virtual input queue to the egress scheduler. This ensures that when incoming data to the virtual output queue ends, the scheduler does not issue credits faster than the virtual output queue can signal changes to the effective credit rates.

### BACKGROUND

This disclosure relates generally to scheduling egress in networking systems and particularly to credit requests for virtual output queues.

A system of networking devices form a network for receiving and transporting packets across the network. Packets received at a particular networking device may be routed to various egress ports (i.e., output ports) across the network for accessing destinations at different points in the network. The output ports may be local to a device or may be located one, two, or more hops away from the networking device. Rather than immediately sending packets to an output port, traffic flows associated with an output port may be coordinated by an egress scheduler. Effectively managing these flows with the egress scheduler across the network are essential for optimizing port usage.

### BRIEF DESCRIPTION OF THE DRAWINGS

FIG. (FIG. 1A shows an example networking environment in which networking devices may use egress credits to control networking traffic, according to one embodiment.

FIG. 1B shows example components of a networking device, according to one embodiment.

FIG. 2 illustrates the use of virtual output queues to manage delivery of packets to egress ports, according to one embodiment.

FIG. 3 shows an example graph of virtual output queue size over time based on requested egress credit rates and related round-trip time, according to one embodiment.

FIG. 4 shows an example graph of egress credit rates and thresholds that may result in unused egress credits.

FIG. 5 shows an example graph with credit rate thresholds set based on the round-trip time, according to one embodiment.

FIG. 6 is a flowchart for a method of managing an egress rate table based on round-trip time, according to one embodiment.

FIG. 7 is a flowchart for a method of using an egress rate table based on round-trip time, according to one embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### Overview

When packets for an egress port are received by a networking device, the packets are enqueued in a virtual output queue. Egress credits are requested from the egress scheduler and packets are sent from the virtual output queue when egress credits are received from the egress scheduler. The number of egress credits requested for the virtual output queue may be based on the size of the virtual output queue (i.e., the number of packets bytes in the virtual output queue). However, in many cases (e.g., incoming packets directed to the egress port suddenly stop arriving) excess credits may be provided for a virtual output queue that are not used, preventing effective use of those credits by other virtual output queues. The number of these excess credits that are unused may relatively increase with higher latency to the egress scheduler and the higher credit request rates.

To prevent excess unused egress credits (resulting in unused capacity and reduced utilization of the egress port), the queue size threshold for changing requesting different quantities of egress credits are optimized to account for the round-trip time (RTT) to the egress credit scheduler. The round-trip time can affect the time between the request for a different rate of egress credits and when the different rate becomes effective from the perspective of the virtual output queue. That is, when a virtual output queue determines to request a lower rate of egress credits, it will not receive a lower rate of egress credits until the request is received at the egress scheduler and the modified rate of egress credits is returned to the virtual output queue. Thus, to reduce potential loss of unused credits allocated to the virtual output queue, the threshold for requesting fewer credits may be based on the egress credit rate and the round-trip time to the egress port. As the egress port may be at different locations across a network (e.g., a local device, 1-hop, 2-hops, etc. away), different egress ports may have different round-trip times. As such, different virtual output queues (associated with different egress ports) may use different queue size thresholds for requesting different egress credit rates. Each of the different queues may differ based on the latency to each associated egress ports. In addition, the thresholds may also be specified based on the minimum credit amount issued by the egress scheduler and traffic class priority.

### System Environment

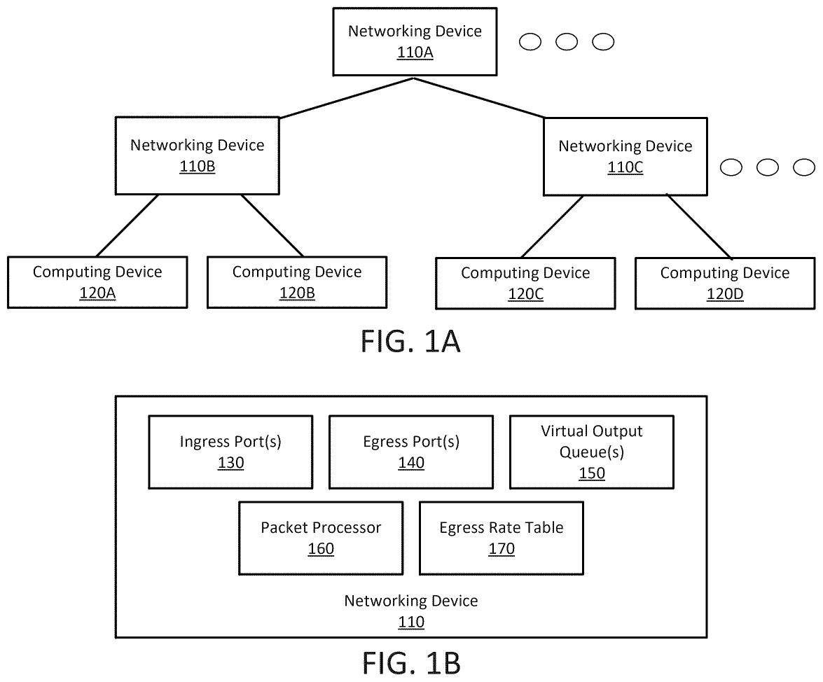

FIG. (FIG. 1A shows an example networking environment in which networking devices may use egress credits to control networking traffic, according to one embodiment. The networking devices may optimize the requested rates for egress credits based on a delay (e.g., based on a round-trip time) to the respective egress port, increasing the utilization of the egress port and reducing the likelihood that requested credits are wasted. The networking devices and related processes discussed herein may also be applied to different networking configurations and architectures, such that the particular arrangement shown in FIG. 1 shows one example architecture in which these approaches may be applied. In general, the networking devices 110A-C provide various network switching and routing services between various computing devices 120A-D and may provide networking services with L2 and/or L3 network addressing (e.g., including handling with Media Access Control (MAC) and Internet Protocol (IP) addresses). The different computing devices 120A-D communicate with packets including a payload for delivery and header information describing various information for handling processing of the packet during network communication, which may include information about the source, destination, sequence information, priority information, data type, and so forth. Although a number of components such as networking devices 110A-C and computing devices 120 are shown in FIG. 1, in practice, any number of these devices may be included in various configurations, which may be private networks and include connections to external networks, such as the Internet.

In the environment of FIG. 1, each networking device 110B-C is connected directly to computing devices 120A-D. The connected computing devices 120 of each networking device 110B-C represent the local computing devices for the respective networking devices. In this example, the computing devices 120A-B are connected locally (i.e., directly) to networking device 110B, and computing devices 120C-D are connected locally to networking device 110C. The networking devices 110 may be configured in various networking architectures, such as a spine and leaf architecture in which networking devices 110 operating as a “leaf” (e.g., networking devices 110B-C) connects to other leaf devices via a set of spine networking devices (e.g., via networking device 110A). Additional networking devices (not shown) may be included in various architectures and provide further switching and forwarding for data related to the computing devices 120. As another example, the networking devices 110B-C may also be a “top-of-rack” device connected to a group of computing devices 120 on a server rack and provides a connection to other devices at other racks in a data center, across different data centers, or across a broader network (e.g., the Internet). The networking devices 110B-C may thus be physically remote from one another (such as networking device 110B relative to networking device 110C) and accessible via various intermediate communication links and further networking devices.

Each networking device 110 provides networking services for communication with other devices across the overall network (e.g., to and from computing devices 120 connected to other networking devices 110). For example, networking device 110A may receive packets from computing device 120B for delivery to computing device 120D via networking device 120C. As discussed further below, the networking devices 110 may coordinate transmission of packets to different networking devices based on egress credits.

FIG. 1B shows example components of a networking device 110, according to one embodiment. In practice, implementations of the networking device 110 may include more or fewer components than shown in FIG. 1B, such as additional control plane and data plane components. In addition, the components shown in networking device 110 may be generally implemented in hardware or other specialized circuits to optimize delivery and processing speed and capability of the networking device 110 and the overall network formed by the networking devices. Embodiments of the networking device 110 may implement additional capabilities than those expressly discussed herein.

Each networking device 110 may include a number of ingress ports 130 at which packets are received by the networking device 110 for switching and forwarding through the network. The networking device 110 processes the packet with the packet processor 160 to identify an egress port 140 for the packet. The packet processor may determine a respective egress port for a packet based on, for example, a destination address in a packet header in conjunction with a routing and forwarding table. To control potential congestion at an egress port 140, rather than immediately send the packet, the packet delivery from a networking device 110 may be managed with egress credits issued by an egress scheduler for the egress port 140. The egress credits specify an amount of data or packets permitted to be sent to the egress port that will be processed by the egress port for delivery to a subsequent device. Received packets may be stored in a virtual output queue 150 associated with a particular egress port and egress credits are requested before sending packets from the virtual output queue to the respective egress port. An egress rate table 170 may specify the various maximum rates at which to request egress credits (i.e., a particular bandwidth, size, or number of egress credits at a given time) and conditions for selecting which egress rate to request. Use of these components and related management of egress credits is discussed further below.

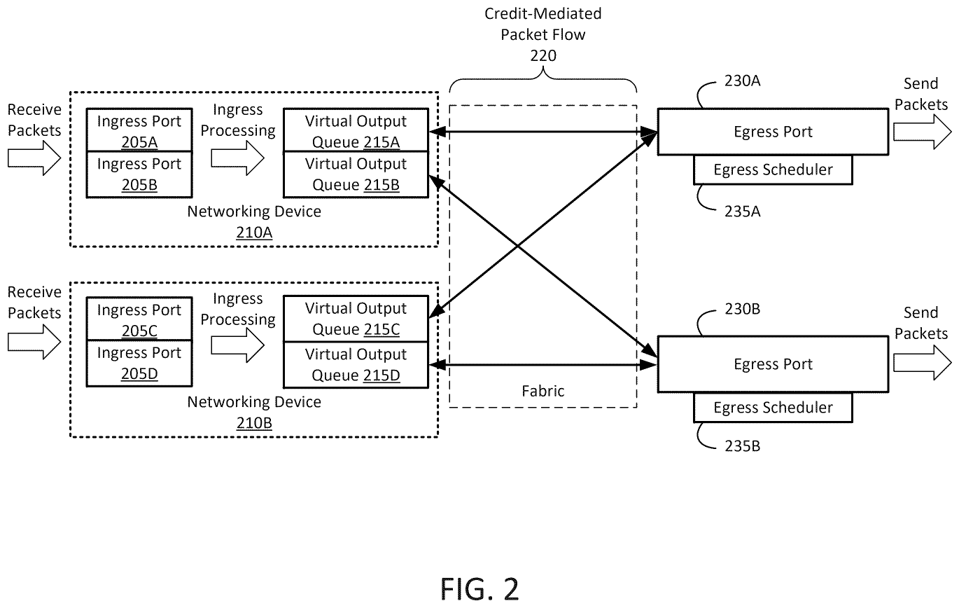

FIG. 2 illustrates the use of virtual output queues 215 to manage delivery of packets to egress ports 230, according to one embodiment. FIG. 2 shows an example of two networking devices 210A-B that receive packets and send packets for egress at egress ports 230A-B. The virtual output queues 215A-D may be used to manage egress of received packet data at egress ports 230 that coordinate with networking devices 210 across a network fabric.

As such, individual egress ports 230A-B may be located on the same or on different networking devices than networking devices 210A-B. That is, networking device 210A may receive packets and manage egress to egress port 230A that is located on a different networking device, such as a separate networking linecard or a separate networking device across the network. The egress ports 230A may thus be local (on the networking device), one, two, three, or more hops away from the networking device in the network that receives the packets.

Each networking device 210 may have a virtual output queue 215 for storing data related to each unique egress port for received packets at the networking device 210. The virtual output queues 215 may be dynamically allocated, such that when a destination egress port 230 for a packet is identified, the packet is enqueued at the associated virtual output queue 215 and, when no virtual output queue exists, a virtual output queue is created for that egress port and the packet is added. Together, the coordination between egress ports 230 and ingress ports 205 may enable effective distributed control of egress port bandwidth across the network fabric.

When packets are received by a networking device 210, the packets are received at a particular ingress port 205. In the example of FIG. 2, networking device 210A includes ingress ports 205A-B; networking device 210B includes ingress ports 205C-D. To process incoming packets, the packets are inspected to determine an egress port 230 in the network, each of which may be associated with a local virtual output queue 215. For example, a received packet at ingress port 205A in networking device 210A may be identified as having egress port 230B as a destination, in which case the packet may be added to corresponding virtual output queue 215B. Similarly, packets to be sent to egress port 230B received at ingress ports 205C-D on networking device 210B may be added to virtual output queue 215D. In this example, virtual output queues 215A, C are associated with egress port 230A, while virtual output queues 215B, D are associated with egress port 230B.

Each egress port 230 has an associated egress scheduler 235 that allocates egress credits. The egress scheduler sends credits to requesting virtual output queues (e.g., at different networking devices) to mediate traffic flow to the egress port. The egress scheduler may allocate credits to individual virtual output queues in various ways, and may account for traffic class prioritization, prevent starvation, and handle related allocation decisions when requested traffic flows exceed available port speeds for the related egress port. In the example of FIG. 2, for example, the egress scheduler 235A associated with egress port 230A allocates egress credits for virtual output queues 215A, 215C. Similarly, the egress scheduler 235B associated with egress port 230B allocates egress credits for virtual output queues 215B, 215D. In general, the egress scheduler 235 distributes egress credits to the requesting virtual output queues based on the available capacity of the associated egress port, such that because the virtual output queues request particular egress credit rates, the egress scheduler 235 may allocate egress credits to optimize throughput of the egress port 230 and coordinate traffic across the network fabric destined for egress via the related egress port. Together, this provides for a credit-mediated packet flow 220 in which virtual output queues 215 buffer data for egress ports 230 and send related data when egress credits are received at the virtual output queue.

However, as data is continually added to the virtual output queues (typically at varying rates) and is sent to the egress port based on the allocated credits, the requested credit rate may change over time. In addition, because the credit allocation is performed by the egress scheduler (typically local to the egress port), the effective rate for a virtual output queue (i.e., the current rate at which credits are received and data is sent) may not change immediately after the queue size of the virtual output queue passes a threshold for a different requested egress credit rate. Instead, the effective egress credit rate may not change until the different requested egress credit rate is received by the egress scheduler and the different egress credit rate is received by the virtual output queue. As such, the round-trip time to the egress scheduler (and any related processing delays in modifying the egress scheduler's allocation) can affect when a different egress credit rate becomes effective.

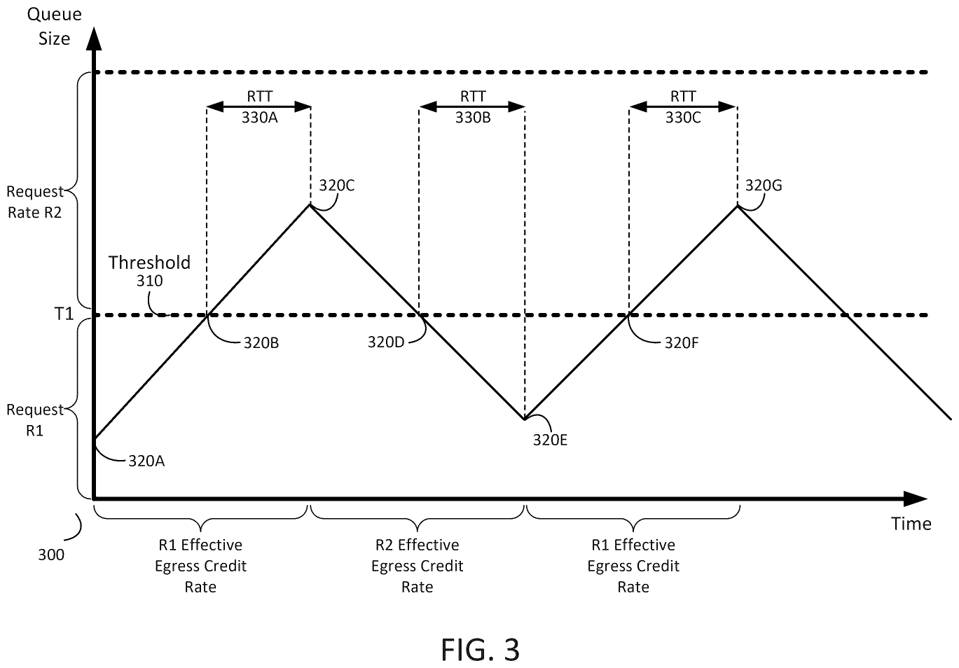

FIG. 3 shows an example graph 300 of virtual output queue size over time based on requested egress credit rates and related round-trip time, according to one embodiment. In the example of FIG. 3, the queue size of a virtual output queue is graphed across time. As discussed above, the queue size may be used to determine the requested egress rate sent to the egress scheduler. In this example, the egress rates may also be referred to as “speeds” for convenience and are designated “R1,” “R2,” etc. for increasing rates. As discussed above, different egress credit rates may be requested by the virtual output queue based on the queue size as shown on the left side of graph 300. A threshold 310 of the queue size is used for requesting the first egress credit rate R1 or the second egress credit rate R2. That is, when the current queue size is between zero and T1, the lowest egress credit rate R1 is requested by the virtual output queue, while when the current queue size is above T1, the next egress credit rate R2 is requested. Stated another way, below the threshold 310, the virtual output queue requests egress credit rate R1, and above the threshold 310, the virtual output queue requests egress credit rate R2. In further examples below, additional thresholds (T1, T2, T3, etc.) are used to separate additional egress credit rates.

In the simulated example of FIG. 3, additional data is continuously added to the virtual output queue at a rate that exceeds R1 but is smaller than R2. As discussed below, this may cause the requested credit rate to alternate between request rates R1 and R2 as the current queue rises above or falls below the threshold 310.

At the bottom of graph 300, the effective egress credit rate for the virtual output queue is indicated with brackets as it changes over time. Because the virtual output queue requests credits from the egress scheduler, requested egress credit rates are not effective until the request is received by the egress scheduler and the egress scheduler notifies the virtual output queue of the new effective rate (e.g., by issuing credits at the new effective rate). FIG. 3 shows example effects of the delay between requested and effective rates.

Although shown in FIGS. 3-5 and discussed below as a “round-trip time” for convenience, similar concepts may apply generally to a credit delay time that describes an amount of time after the size of the virtual output queue passes a threshold for changing a requested egress credit rate and the requested credit rate is effective from the perspective of the virtual output queue (i.e., the rate the credits are received and can be used to send data to the egress port). As such, the credit delay time in some embodiments may include the round-trip time to the associated egress port and/or other factors that affect the amount of time to change the effective credit rate.

Initially, at point 320A, the queue size is below the threshold 310 and the egress credit rate is requested at the first rate R1. Because data is added to the virtual output queue faster than the first rate R1, the queue size increases over time to a point 320B at which the queue size reaches the threshold 310. As the queue size is equal to/exceeds the threshold 310, the virtual output queue (e.g., via the packet processor) requests the second rate R2. While the request for the second rate R2 is en route, the previous rate may continue to be effective until a response is received with the updated rate R2. That is, because the request must be received by the egress scheduler and the updated credit rate must be received by the virtual output queue, until a round-trip time (RTT) 330A for the messaging to and from the egress scheduler is complete, the effective egress credit rate remains R1. As such, from the point 320B until a point 320C when the RTT 330A is completed, the effective egress credit rate remains the first rate R1. When the response from the egress scheduler is received at point 320C, the requested higher credit rate R2 becomes effective.

As the second rate R2 is higher than the rate that new data is added to the virtual output queue (in this example), the queue size decreases from point 320C back towards the threshold T1. When the queue size reaches the threshold T1 at point 320D, the first rate R1 is requested. As before, the effective rate is not changed until another round-trip time RTT 330B to the egress scheduler for the egress port as the scheduler processes and replies to the requested speed. As such, the virtual output queue continues to receive egress credits (and send data) at the second rate R2 until the response is received at point 320E, at which point the effective egress credit rate is R1. Finally, the size of the virtual output queue may increase from point 320E to point 320F as the added data is higher than R1. When the threshold 310 is passed at point 320F, the second rate R2 is requested, but does not become effective until point 320G when round-trip time 330C has passed from point 320F. As shown by this example, the round-trip time may introduce a delay between the thresholds for requesting a change to the egress credit rate and when a changed rate is effective. Although the example of FIG. 3 shows the possible “alternation” between requested speeds that may occur in which egress credits are effectively used to manage the data flow, in many situations, the egress credits may be ineffectively used and can be improperly allocated due to the delay from the round-trip time 330. This may particularly occur when incoming data to an egress port stops.

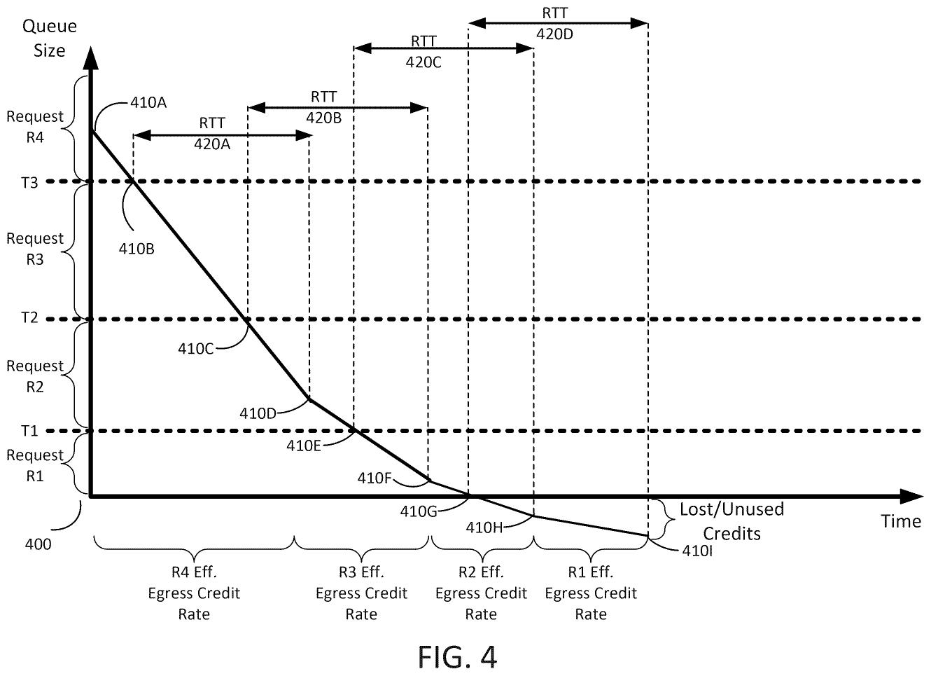

FIG. 4 shows an example graph 400 of egress credit rates and thresholds that may result in unused egress credits. In this example, a number of egress credit rates R1-R4 (decreasing from R4 to R1) are separated by thresholds T1-T3. At an initial point 410A, the queue size is above threshold T3 and corresponds to a requested (and effective) egress credit rate R4. In this example, the rate of incoming data/packets for the virtual output queue is zero (i.e., at the point 410A, the incoming packets for the virtual output queue has stopped). In these circumstances as shown in this example, the particular egress credit rates and round-trip times 420 may result in credits allocated to the virtual output queue that are not used by the virtual output queue.

As the virtual output queue sends packets according to the received credits, the queue size reduces until the threshold T3 between rates R4 and R3 is reached, and a request is sent to change the credit rate to R3. However, during the related round-trip time 420A, before the requested rate R3 becomes effective, data may continue to be sent from the virtual output queue at the prior rate, R4, from point 410B through 410C and 410D as credits are received at rate R4. Next, at point 410C, the queue size reaches threshold T2 between rates R3 and R2, such that at point 410C, another request is sent to change the credit rate to R2, with related round-trip time 420B. As such, due to the delay in communicating requested credit rate changes with the egress scheduler, the queue size may pass through more than one threshold before a requested credit rate change becomes effective, particularly when the incoming data for a particular virtual output queue significantly reduces (e.g., to zero).

FIG. 4 illustrates example behavior related to these round-trip times 420A-D and rates R1-4 as the thresholds T1-3 are passed and the queue is depleted. When the requested change to rate R3 occurs at point 410D, the request for rate R2 has already been sent at point 400C. As such, the effective speed at point 400D becomes R3 and continues at R3 at point 400E while passing threshold T1 for requesting rate R1. As with prior requests, the requested rate R1 is not effective until completing the round-trip time 410C. Data may continue to be sent at rate R3 until the response is received for speed R2 at point 410F. After point 410F, rate R2 is effective and the virtual output queue continues to send data at rate R2 until the queue is empty at point 410G. At point 410G, a request to stop receiving egress credits may be sent, indicating the queue is empty. However, egress credit rate R2 may still be effective, such that the egress scheduler continues to issue credits and expect data from the virtual output queue to use available bandwidth at the egress port based on the issued credits. As such, there may be excess egress credits allocated to the virtual output queue that reduce the effective throughput of the egress port (i.e., because the allocated credits could have been allocated to another requesting virtual output queue associated with for the same egress port).

As illustrated by the example in FIG. 4, relatively high speeds and relatively longer round-trip times can cause the virtual output queue to empty more quickly than the requested threshold speeds may be intended to and result in excess credits to be issued to that virtual output queue, resulting in lowered usage of the egress port and potentially delaying data at other virtual output queues. While the example of FIG. 4 shows higher speeds/longer round-trip times in conjunction with relatively low thresholds for transitioning between speeds may yield inefficient credit allocation, ineffective usage may also occur when the opposite combination occurs (relatively low speeds, low RTT, and high thresholds). In this situation, although excess credits are less likely to be allocated, network performance may be degraded because latency of data in the virtual output queue unnecessarily increases. In this situation, slower speeds and higher thresholds for switching between them may significantly increase the amount of time that an average packet is held in the virtual output queue, even if there may be capacity at the egress port.

To optimize performance of the virtual output queue, the requested credit rates (i.e., speeds) and thresholds for transitioning between them may be determined based on the round-trip time from the virtual output queue to the egress port/egress scheduler. This reduces the potential for excess egress credits issued to the virtual output queue and unused egress credits while minimizing latency within the virtual output queue.

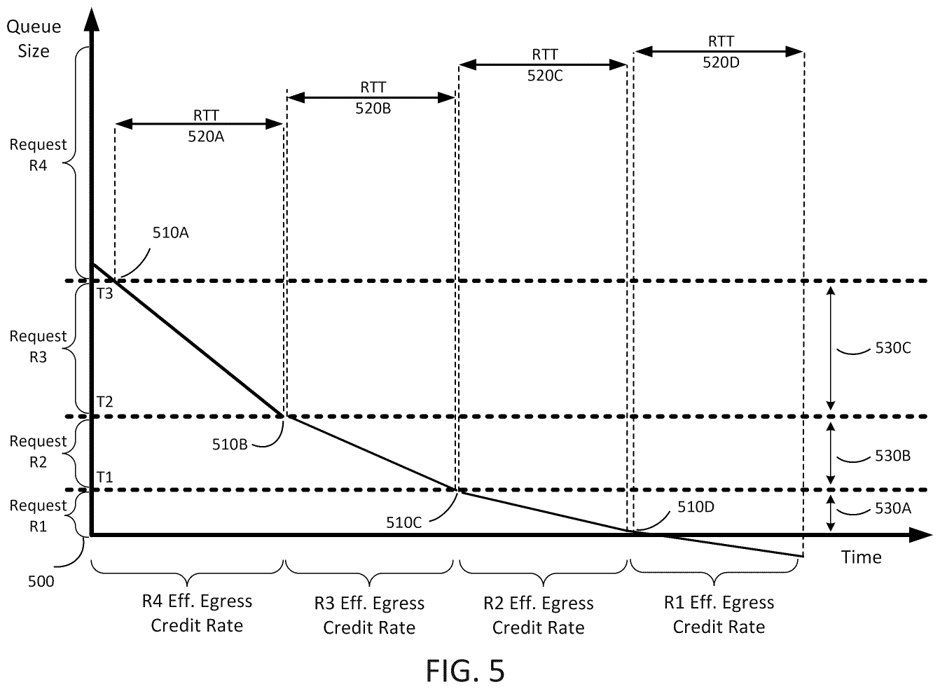

FIG. 5 shows an example graph 500 with credit rate thresholds set based on the round-trip time, according to one embodiment. As with FIG. 4, this example graph 500 illustrates a stop of incoming data to a virtual output queue that has a set of credit rates R1-R4 to be requested based on a set of thresholds T1-T3. In this example, the virtual output queue initially has a requested and effective credit rate of R4.

To reduce unused credits, particularly when incoming data to the virtual output queue stops, the thresholds T1-T3 may be set based on the round-trip time to the egress scheduler. In general, the incremental queue size for each threshold may be based on the round-trip time 520 and the rate of the higher credit rate above the threshold. For example, threshold T1 between rates R1 and R2 may be based on rate R2 multiplied by the round-trip time. That is, when the queue size is falling (such as when incoming data stops), the threshold for returning to the lower rate is set such that the subsequent threshold is not reached until the roundtrip time for adjusting the current effective credit rate. As such, a threshold difference 530A between T1 and TO (at which point the queue is empty) in one embodiment is the round-trip time 520 multiplied by the rate R2. Similarly, a threshold difference 530B between T2 and T1 (i.e., the value of threshold T2 minus threshold T1) in one embodiment is the round-trip time 520 multiplied by the rate R3. Finally, a threshold difference 530C between T3 and T2 (threshold T3 minus threshold T2) is the round-trip time 520 multiplied by the rate R4.

As shown in FIG. 5, this results in a requested egress rate becoming the effective egress rate before a subsequent threshold is reached, even when no data is being added to the virtual output queue. As in the example of FIG. 4, the graph 500 begins with an effective rate R4. At point 510A, the threshold T3 between R4 and R3 is reached, and rate R3 is requested. After a RTT 520A, egress rate R3 becomes effective at point 510B, which is before or at approximately the same time that the queue size is reduced to the value of the threshold T2 for requesting rate R2. At approximately point 510B, when the queue size reaches and falls below the threshold T2, rate R2 is requested and becomes effective after an RTT 520B. Requested rate R2 becomes effective at point 510C, approximately the same time or before the queue size is at the threshold T1 for requesting rate R1. R1 is requested when T1 is reached and becomes effective at 520C. Because the threshold T1 is set based on the RTT and the upper rate (R2), although the effective rate is R2 when the threshold T1 is passed, the requested rate R1 becomes effective before point 510D when the queue size is depleted. By setting the thresholds based on the RTT, the possibility of unused credits is minimized, and the credits may be unused at the lowest credit rate.

In some embodiments, the lowest credit rate R1 is a single credit (i.e., a minimum size issued by the scheduler), such that the egress scheduler may not issue another credit until that credit has been used. In these instances, when the final set of data set at credit rate R1 is sent (depleting the queue size), a request to stop receiving credits may be sent, such that the egress scheduler receives the request to stop receiving credits at substantially the same time and preferably immediately before it was about to issue another credit, preventing additional or excess credits from being issued. Because this approach can ensure a requested rate is effective before the next threshold is passed, additional credits are not wasted due to higher effective credit rates.

In one embodiment, the egress rate table (also referred to as a “rate table”) may be generated by a packet processor or controller (e.g., a control plane) of the networking device and stored for use by associated virtual output queues. The process for generating the rate table may thus be performed by a processor or other processing element and may include execution of instructions stored on a memory (e.g., a non-transitory computer-readable medium). To generate the rate table, the controller may initially determine the egress credit rates that may be used in the table. The egress credit rates may begin with an initial rate based on the minimum number of egress credits that can be issued by the egress scheduler and the round trip time to the requesting virtual output queue for the associated egress port of a virtual output queue. For example, the minimum egress credit rate may be one credit (e.g., 4 Kb). A maximum credit rate may be based on a maximum egress rate that can be issued by the egress scheduler and/or a maximum port rate of the egress port. Additional egress credit rates may be determined between the minimum and maximum egress credit rates.

In one embodiment, the egress credit rates may geometrically increase (e.g., a geometric progression), such that each increasing egress credit rate is a multiple of the prior egress credit rate. In one example embodiment, each egress credit rate is a multiple of two of the previous egress credit rate. In this example, the second egress credit rate R2 is twice the first egress credit rate R1. Similarly, the third egress credit rate R3 is twice the second egress credit rate R2, and so on. Additional values, such as 3, 4, or 5, may be used as the geometric multiplier for determining credit rates. In additional examples, the credit rates that may be requested may also be pre-set by the egress scheduler.

To generate a rate table that specifies the egress credit rates and thresholds for selecting each egress rate, the round-trip time to the relevant egress port is determined by sending a message to the egress scheduler for the associated egress port and measuring the time until a response is received. Next, the thresholds for transitioning between requested egress credit rates may be determined from the lowest egress credit rate to the highest. The size of the threshold increase for each threshold may be determined based on the round-trip time and the requested egress credit rate above the threshold. As such, the threshold T1 from rate R1 to rate R2 may be based on the round-trip time and the rate R2. The threshold T2 be the threshold T1 plus an amount based on the round-trip time and the rate R3. Table 1 shows example thresholds T1-T3, the requested credit rate above and below each threshold, and the threshold value for each threshold.

TABLE 1

| | Requested Credit | Requested Credit | |
|---|---|---|---|
| | Rate Below | Rate Above | |
| Threshold | Threshold | Threshold | Threshold Value |
| T1 | R1 | R2 | T1 = (R2 * RTT) |
| T2 | R2 | R3 | T2 = T1 + (R3 * RTT) |
| T3 | R3 | R4 | T3 = T2 + (R4 * RTT) |

As shown in the example of Table 1, the thresholds may be constructed from the lowest threshold towards the highest threshold while reducing (or completely preventing) unused credits while maximizing the use of higher rates and reducing latency in the virtual output queue. Table 1 may be used as a credit rate table used by the virtual output queue to select a credit rate. Various embodiments may implement the credit rate table in various ways, for example, to organize the data of Table 1 as a lookup table based on the current queue size of the virtual output queue and output the requested credit rate. For example, credit rate R2 is the requested credit rate when the queue size is between T1 and T2.

In additional embodiments, the thresholds may be generated based on the round-trip time and the credit rates in additional ways and/or with additional considerations. For example, the threshold values may be adjusted upwards or downwards to prioritize traffic types, prioritize latency, or prioritize prevention of credit loss. For example, the thresholds may be reduced from the threshold values noted above to prioritize latency, such as for higher-priority traffic, while enabling a known tradeoff with the likelihood of unused credits.

In further embodiments, the configuration of the rate tables may be specified by a network administrator or pre-set for various network configurations based on configured credit rates and expected round-trip times. For example, certain networking device configurations may have relatively consistent round-trip times, such that the configurations of the rate tables may be consistent.

In one embodiment, a plurality of rate tables may be used that correspond to various networking device configurations. For example, one rate table may be associated with local egress ports (i.e., the egress scheduler is local to the device with the associated virtual output queue), and another rate table may be associated with egress ports one-hop away, while another rate table is associated with egress ports two-hops away. The configuration of the egress ports may then be used to select the rate table used for a particular virtual output queue based on the configuration of the egress port. The configurations may generally reflect different round-trip times that may be expected to be relatively consistent, such that the same rate table may be used for all egress ports associated with the same configuration.

As such, in some instances a plurality of rate tables may be used to combine settings for egress ports having similar round-trip times and other parameters into one rate table. For example, the number of hops to reach a device may be an effective proxy for the expected round-trip time. In one embodiment, a networking device may measure round-trip times and assign an associated virtual output queue to a rate table based on the measured round-trip time, such that virtual output queues having similarly-measured round-trip times may be assigned to the same rate table. As such, individual networking devices may have different rate tables for different virtual output queues. Likewise, for a particular egress port, the plurality of virtual output queues (which may be dispersed across the network) may have different rate tables based on the round-trip time to that egress port, enabling different configurations that reduce unused credits without too-conservatively setting the thresholds and thereby increasing latency.

Together, these enable settings for virtual output queues to optimize credit rate requests and account for the variation of round-trip time across different configurations.

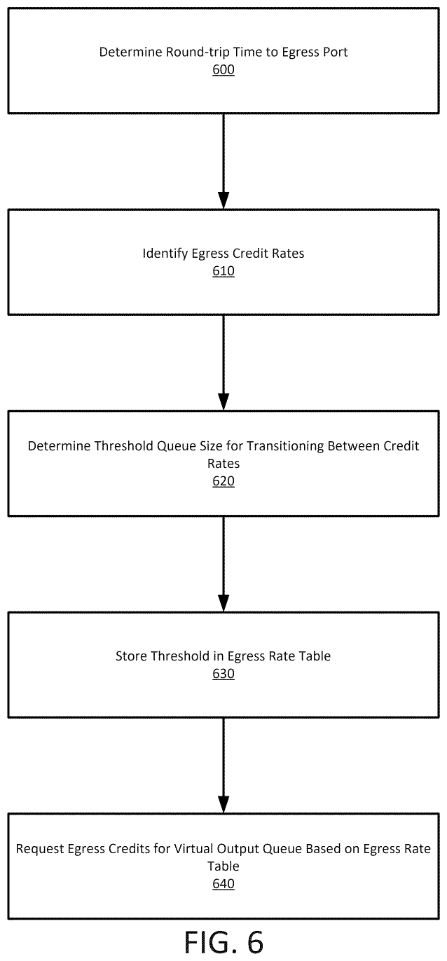

FIG. 6 is a flowchart for a method of managing an egress rate table based on round-trip time, according to one embodiment. The method shown FIG. 6 may be performed, for example, by a networking device such as networking device 110. This method may be performed, for example, for a virtual output queue having an associated egress port managed by an egress queue. As discussed above, the values for the egress rate table may be determined automatically, such as by a networking device or by other means.

Initially, a round-trip time to the relevant egress port is determined 600. The round-trip time may indicate an expected amount of time for changes to the egress credit rates to become effective. Next, the set of egress credit rates to be used by the egress rate table are identified 610. As discussed above, the egress credit rates may include a plurality of egress credit rates, and in one embodiment may include a range of egress credit rates from a minimum credit rate to a full port rate of the egress port. In some embodiments, the minimum credit rate is determined based on a credit size of the egress credits issued by the egress scheduler and the round-trip time (e.g., the product of the credit size and the round-trip time). The plurality of egress credit rates are geometrically increasing in one embodiment.

The round-trip time may then be used to determine the threshold queue sizes for transitioning between credit rates. For example, and as also discussed above, the threshold between a first credit rate and a second credit rate, higher than the first credit rate, may be set based on the round-trip time multiplied by the second credit rate. That is, the threshold may be set based on the higher credit rate and the round-trip time, such that the threshold is high enough that the lower credit rate becomes effective before a threshold below the lower credit rate is reached. These are discussed, for example, in more detail with respect to FIG. 5. Additional thresholds may be determined for transitions between each of the egress credit rates as discussed above. After determining the egress credit rates and thresholds for transitioning between them, the resulting egress credit rate table may be stored 630 for use in managing virtual output queues. When an associated virtual output queue has queued data, egress credits are requested 640 based on the values of the egress rate table. As the size of the virtual output queue increases and decreases, the quantity of requested egress credits may change over time.

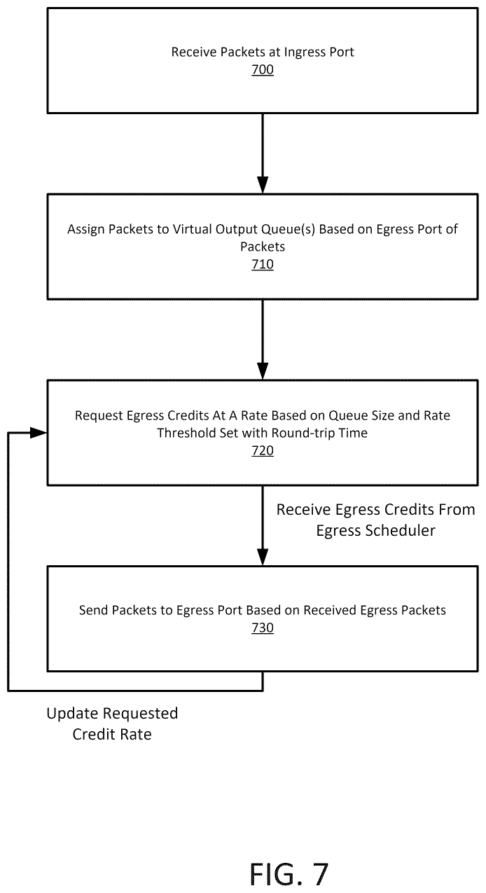

FIG. 7 is a flowchart for a method of using an egress rate table based on round-trip time, according to one embodiment. This method may be performed, for example, by a networking device as discussed above, such as networking device 110. The networking device may have a plurality of ingress ports that receive packets 700 for delivery to various egress ports in the network. Initially, received packets may be analyzed to determine the respective egress ports for each of the packets and, for egress ports managed with an egress credits and an egress scheduler, the received packets are assigned 710 to respective virtual output queues based on the egress ports associated with the packets. In some embodiments, particular egress ports may be associated with more than one virtual output queue having different characteristics for different virtual output queue management. For example, different virtual output queues may be associated with different traffic classes (e.g., priority levels), such that the virtual output queue for a particular packet may depend on the egress port and a traffic class associated with the packet.

Each of the virtual output queues may then be managed according to an associated egress rate table. As discussed above, the various egress rate tables may have different egress credit rates and thresholds for transitioning between egress credit rates that are based on a round-trip time to the egress scheduler. For example, one egress rate table may specify a first rate and a threshold for transitioning to a second rate. The threshold for transitioning to the second rate may be based on the round-trip time and the first rate (e.g., the higher rate). To manage credit requests for the virtual output queue, egress credits are requested 720 at a rate that is based on the queue size. In this example, the queue size may initially be higher than the threshold, such that credits are requested at the first rate. As egress credits are received from the egress scheduler, packets are sent to the egress port 730. The size of the virtual output queue may then increase or decrease over time as packets are sent and additional packets may be assigned 710. The current rate to request egress credits may then be re-evaluated to request 710 additional egress credits based on the current queue size. In this example, when the queue size is reduced and reaches (or is below) the threshold, the second rate of egress credits is requested. Because the thresholds for requesting egress credits is based on the round-trip time, the number of excess egress credits issued to the virtual output queue may be reduced or minimized while maintaining low latency for data in the virtual output queue.

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

Some portions of this description describe the embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments is intended to be illustrative, but not limiting, of the scope, which is set forth in the following claims.

1. A networking device with credit request thresholds based on egress credit delay time, comprising:
an ingress port that receives packets for processing;
a plurality of virtual output queues each associated with a respective egress port, each virtual output queue configured to send packets to the egress port based on received egress credits; and
a packet processor configured to:
assign packets to one of the plurality of virtual output queues based on respective destinations of the packets;
determine an egress credit rate for a first virtual output queue of the plurality of virtual output queues from an egress rate table of egress credit rates based on the size of the first virtual output queue; the egress rate table having thresholds for selecting the egress credit rate based on an egress credit delay time including at least a round-trip time to the respective egress port associated with the first virtual output queue; and
request egress credits for the first virtual output queue at the egress credit rate.

2. The device of claim 1, wherein the packet processor is further configured to:
determine another egress credit rate for a second virtual output queue of the plurality of virtual output queues from another egress rate table of egress credit rates based on the size of the second virtual output queue, wherein the other egress rate table has thresholds for selecting the other egress credit rate that differs from the egress rate table for the egress port associated with the first virtual output queue, the other egress rate table based on another egress credit delay time including at least a round-trip time to the respective egress port associated with the second virtual output queue; and
request egress credits for the second virtual output queue at the determined other egress credit rate.

3. The device of claim 1 wherein the egress rate table is based on a number of hops to a networking device associated with the first virtual output queue.

4. The device of claim 1, wherein the packet processor is further configured to determine the egress credit delay time and set at least one threshold in the egress rate table based on the egress credit delay time.

5. The device of claim 1, wherein the lowest rate in the egress rate table for the first virtual output queue is the division of a credit size by the round-trip time.

6. The device of claim 1, wherein the credit rates of the table are a geometric progression.

7. The device of claim 6, wherein the geometric progression is from a minimum credit request rate to a full port rate associated with the first virtual output queue.

8. The device of claim 1, wherein at least one threshold between a lower speed and a higher speed is substantially equal to the product of the delay and the higher speed plus a threshold for the lower speed.

9. A method for managing egress credits across networking devices, comprising:
receiving packets at an ingress port of a networking device;
assigning received packets associated with a first egress port to a first virtual output queue based on respective egress ports of the packets;
requesting egress credits from an egress scheduler for the egress port at a first rate based on a queue size of the virtual output queue;
requesting egress credits from the egress scheduler for the egress port at a second rate, smaller than the first rate, when the queue size is below a first threshold that is based on an egress credit delay time including at least a round-trip time to the egress scheduler; and
sending packets to the egress port from the virtual output queue based on received egress credits.

10. The method of claim 9, further comprising:
determining the round-trip time to the egress scheduler;
setting the first threshold substantially equal to the round-trip time multiplied by the first rate plus a second threshold for requesting egress credits at a third rate smaller than the second rate.

11. The method of claim 10, wherein the round-trip time is determined based on a number of hops and round-trip transmission time through one or more communication channels connecting the networking device to the egress scheduler.

12. The method of claim 9, further comprising:
selecting an egress rate table that specifies the first rate, the second rate, and the first threshold based on the round-trip time to the egress scheduler.

13. A method for determining an egress rate table for a virtual output queue on a networking device, comprising:
determining a round-trip time to an egress scheduler associated with an egress port;
identifying a plurality of egress credit rates for the egress port, the plurality of egress credit rates including a first egress credit rate and a second egress credit rate higher than the first egress credit rate;
determining a first threshold queue size for transitioning between requesting a first egress credit rate and a second credit rate, the first threshold based on the round-trip time to the egress port multiplied by the second egress credit rate; and
storing the first threshold in an egress rate table for use by a virtual output queue to select an egress credit rate based on the first threshold queue size.

14. The method of claim 13, wherein the first egress credit rate is the division of a credit size by the round-trip time to the egress port.

15. The method of claim 13, wherein the second egress credit rate is a multiple of the first egress credit rate.

16. The method of claim 13, further comprising:
determining a second threshold queue size for transitioning between requesting the second egress credit rate and a third egress credit rate higher than the second egress credit rate, the second threshold based on the round-trip time to the egress port multiplied by the third egress credit rate; and
storing the second threshold queue size in the egress rate table.

17. The method of claim 16, wherein the first egress credit rate, second egress credit rate, and third egress credit rate are a geometric progression.

18. The method of claim 13, wherein the round-trip time is based on a number of hops from the networking device to the egress scheduler.

19. The method of claim 13, further comprising:
selecting an egress credit rate for the virtual output queue based on the egress rate table and a size of the virtual output queue; and
sending a request for the selected egress credit rate to the egress scheduler.

20. The method of claim 13, further comprising determining that the size of the virtual output queue passes the first threshold and selecting another egress credit rate based on the determination.
